(19) United States
(12) Patent Application Publication
(10) Pub. No.: US 2010/0146619 A1
(43) Pub. Date: Jun. 10, 2010

(54) ELECTRONIC DEVICE AND ACCESS CONTROL METHOD THEREOF

(75) Inventor: I-PIN CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/547,654

(22) Filed: Aug. 26, 2009

(30) Foreign Application Priority Data
Dec. 4, 2008 (CN) 200810305952.9

(51) Int. Cl. G06F 7/04

(52) U.S. Cl. 726/19

(57) ABSTRACT

An electronic device and method for controlling access to an electronic device includes setting a username and a password of an authorized user, and creating a keystroke biometric template of the authorized user. The electronic device and method further includes receiving an input username and an input password of a user, and recording keystroke dynamics of the user, and determining an identification of the user by identifying the input username and the input password of the user and determining if keystroke characteristic values of the user match the keystroke biometric template of the authorized user.

### BACKGROUND

1. Technical Field

Embodiments of the present disclosure relate to access control, and more particularly to an electronic device and method for controlling access to the electronic device by identifying keystroke dynamics of users.

2. Description of Related Art

Electronic devices may be used to store various kinds of private information (e.g., personal data, phone lists, message records, trading information and call histories, etc). Since such private information may be confidential, and leakage of such private information may result in many problems. Many electronic devices provide passwords to ensure information security. However, passwords are easily cracked or forgotten.

What is needed, therefore, is an improved electronic device and method for controlling access to the electronic device.

### BRIEF DESCRIPTION OF THE DRAWINGS

FIG. 1 is a block diagram of one embodiment of an electronic device including an identifying system.

FIG. 2 is a block diagram of one embodiment of the identifying system.

FIG. 3 is a flowchart of one embodiment of a method for creating a keystroke biometric template of an authorized user of the electronic device of FIG. 1.

FIG. 4 is a flowchart of one embodiment of a method for controlling access to the electronic device of FIG. 1.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

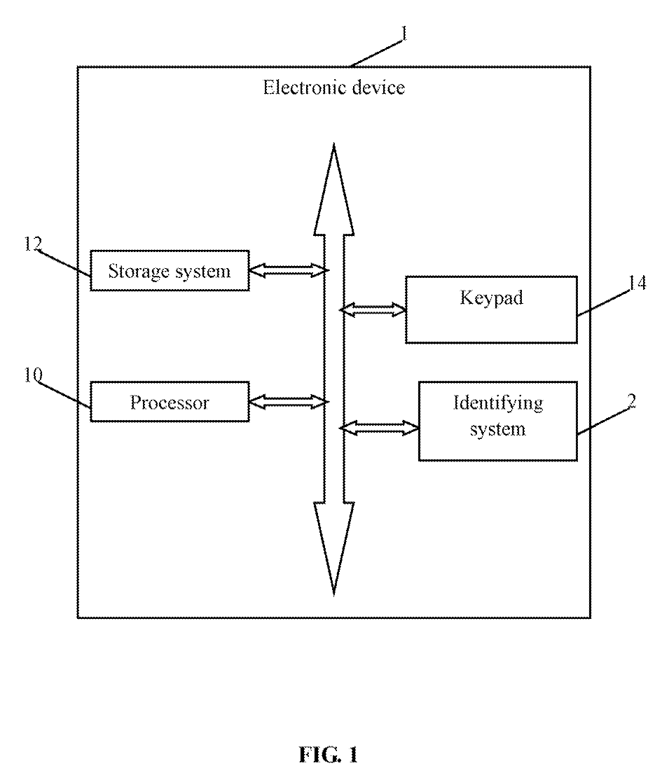

FIG. 1 is a block diagram of one embodiment of an electronic device 1 including an identifying system 2. The identifying system 2 may be used to control access to the electronic device 1 by identifying keystroke dynamics of a user of the electronic device 1. It should be understood that keystroke dynamics uses behavioral biometrics to measure features of keystroke manners, such as keystroke rhythm of a user when the user types characters on a keyboard or a keypad. The keystroke rhythm of the user is measured to create a unique biometric template of user typing pattern.

The electronic device 1 may be a mobile phone, a personal digital assistant (PDA), a handheld computer, or any other kind of computing device. The electronic device 1 also includes a processor 10, a storage system 12, and a keypad 14. The processor 10 executes one or more computerized operations of the electronic device 1 and other applications, to provide functions of the electronic device 1. The storage system 12 stores one or more programs, such as programs of an operating system, other applications of the electronic device 1, and various kinds of data, such as keystroke images, for example. In one embodiment, the electronic device 1 may be a mobile phone, and the storage system 12 may be a memory of the electronic device 1 or an external storage card, such as a memory stick, a subscriber identification module (SIM) card, a smart media card, a compact flash card, or any other type of memory card. The keypad 14 is used to receive input data of the user.

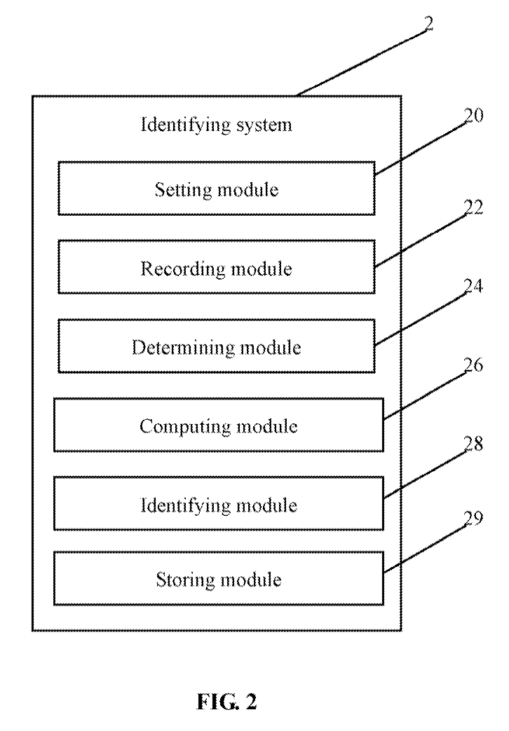

FIG. 2 is a block diagram of one embodiment of the identifying system 2. In one embodiment, the identifying system 2 includes a setting module 20, a recording module 22, a determining module 24, a computing module 26, an identifying module 28, and a storing module 29. The modules 20, 22, 24, 26, 28, and 29 may comprise one or more computerized programs to be executed by the processor 10 to perform one or more operations of the electronic device 1. Details of these operations will be provided below.

First, keystroke biometric templates of one or more authorized users of the electronic device 1 are created and stored into the storage system 12. The keystroke biometric templates may be used to control access to the electronic device 1. The keystroke biometric template of an authorized user can be obtained as follows.

The setting module 20 is used to set a username and a password of the authorized user.

The recording module 22 records keystroke dynamics of the authorized user in response to keystroke actions of the authorized user on the keypad 14. The keystroke dynamics exhibit behavioral features of the authorized user. The keystroke dynamics may include a depressed time of each key of the keypad 14 and an interim time between depression of two keys of the keypad 14, when the authorized user is typing on the keypad 14, for example. In one embodiment, the authorized user may input one or more character strings, which include alphanumeric characters and/or symbols. For example, the character strings may be a segment of an article. The recording module 22 receives the input character strings of the authorized user, and records the depressed time and the interim time corresponding to each character in the input character strings.

For example, a character string “test” is input. A depressed time of the key “t” is recorded as 0.1 second, a depressed time of the key “e” is recorded as 0.15 seconds, a depressed time of the key “s” is recorded as 0.18 seconds, and a depressed time of the key “t” is recorded as 0.1 seconds. An interim time between the keys “t” and “e” is 0.05 seconds, an interim time between the keys “e” and “s” is 0.04 seconds, an interim time between the keys “s” and “t” is 0.03 seconds.

In another embodiment, the authorized user may input the username and the password directly, and the recording module 22 records the keystroke dynamics of the authorized user according to the keystroke actions of inputting the username and the password.

The computing module 26 computes keystroke characteristic values of the authorized user according to the keystroke dynamics. The keystroke characteristic values may include an average depressed time and an average interim time, for example. The average depressed time is computed according to each depressed time of each key to input the character strings or the username and the password of the authorized user. The average interim time is computed according to each interim time between each two keys. As the example mentioned above, the average depressed time of the character string “test” is computed as “(0.1+0.15+0.18+0.1)/4=0.1325 seconds,” and the average interim time is computed as “(0.05+0.04+0.03)/3=0.04 seconds.” If more accurate keystroke characteristic values need to be computed, the authorized user may be prompted to input more character strings.

The storing module 29 creates the keystroke biometric template of the authorized user according to the keystroke characteristic values of the authorized user, and stores the keystroke biometric template of the authorized user into the storage system 12.

By utilizing the recording module 22 and the computing module 26, more keystroke biometric templates of other authorized users may be created and stored into the storage system 12.

If a user wants to log into the electronic device 1, the user may input a username and a password through the keypad 14. The recording module 22 receives the input username and the input password of the user, and records keystroke dynamics of the user in response to keystroke actions on the keypad 14. As mentioned above, the keystroke dynamics may include the depressed time of each key and the interim time between each two keys.

The determining module 24 determines if the input username and the input password are the same as the username and the password of the authorized user.

If the input username and the input password are the same as the username and the password of the authorized user, the computing module 26 computes keystroke characteristic values of the user according to the keystroke dynamics. As mentioned above, the keystroke characteristic values may include the average depressed time and the average interim time, for example.

The identifying module 28 determines if the keystroke characteristic values match the keystroke biometric template of the authorized user. If the keystroke characteristic values match the keystroke biometric template of the authorized user, the identifying module 28 grants access to the electronic device 1. If either of the input username and the input password is different from the username and the password of the authorized user, or the keystroke characteristic values do not match the keystroke biometric template of the authorized user, the identifying module 28 denies access to the electronic device 1.

A comparison percentage may be predefined by the identifying module 28 for requiring a percentage of matching in comparison of the keystroke characteristic values with the keystroke biometric template of the authorized user. In one embodiment, the comparison percentage may be preset as 90%. If the keystroke characteristic values are a 90% match or better to the keystroke biometric template of the authorized user, the identifying module 28 grants access to the electronic device 1.

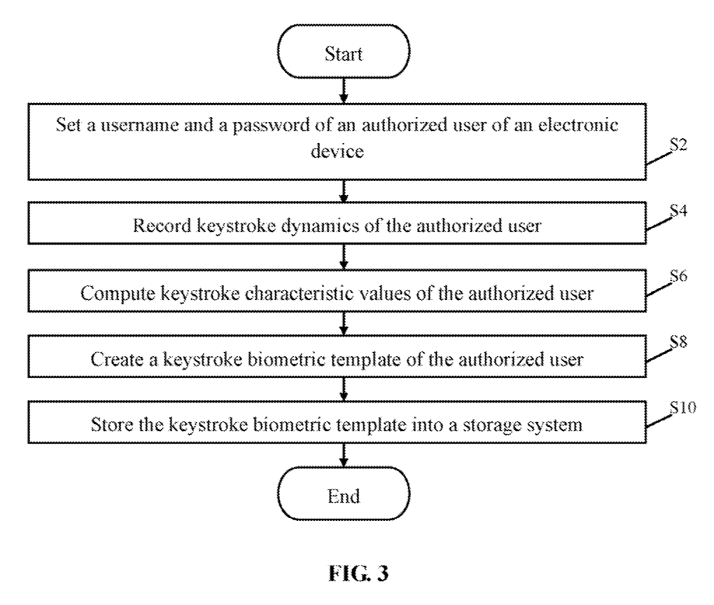

FIG. 3 is a flowchart of one embodiment of a method for creating a keystroke biometric template of an authorized user of the electronic device 1 of FIG. 1. Depending on the embodiment, additional blocks may be added, others removed, and the ordering of the blocks may be replaced.

In block S2, a username and a password of the authorized user is set through the setting module 20.

In block S4, the recording module 22 records keystroke dynamics of the authorized user in response to keystroke actions of the authorized user on the keypad 14. As mentioned above, the keystroke dynamics may include a depressed time of each key of the keypad 14 and an interim time between depression of two keys of the keypad 14. For example, the authorized user may input one or more character strings including alphanumeric characters and/or symbols, or input the username and the password of the authorized user. The recording module 22 receives the input character strings or the input username and password and records the keystroke dynamics of the authorized user.

In block S6, the computing module 26 computes keystroke characteristic values of the authorized user according to the keystroke dynamics. As mentioned above, the keystroke characteristic values may include an average depressed time and an average interim time, for example.

In block S8, the storing module 29 creates the keystroke biometric template of the authorized users according to the keystroke characteristic values of the authorized user.

In block S10, the storing module 29 stores the keystroke biometric template of the authorized user into the storage system 12.

More keystroke biometric templates of other authorized users may be created and stored into the storage system 12 by repeating block S2 to block S10.

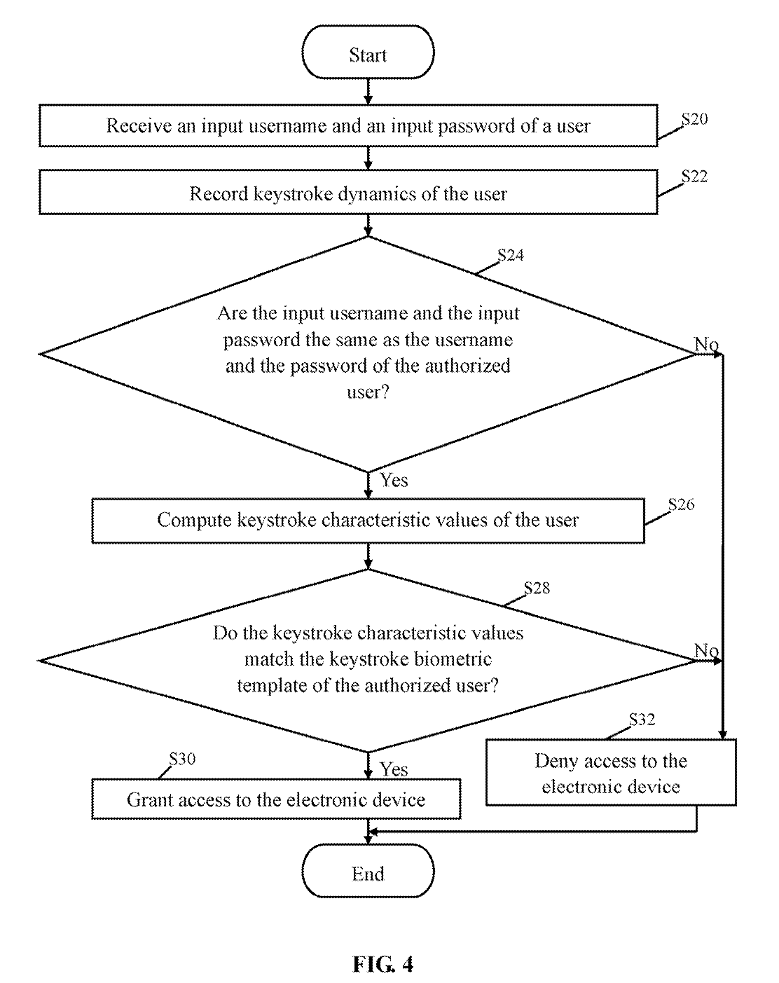

FIG. 4 is a flowchart of one embodiment of a method for controlling access to the electronic device 1 of FIG. 1. Depending on the embodiment, additional blocks may be added, others removed, and the ordering of the blocks may be replaced.

In block S20, the recording module 22 receives an input username and an input password of a user who wants to log into the electronic device 1.

In block S22, the recording module 22 records keystroke dynamics of the user in response to keystroke actions on the keypad 14.

In block S24, the determining module 24 determines if the input username and the input password are the same as the username and the password of the authorized user.

If either of the input username and the input password is different from the username and the password of the authorized user, the procedure goes to block S32 directly.

If the input username and the input password are the same as the username and the password of the authorized user, in block S26, the computing module 26 computes keystroke characteristic values of the user according to the keystroke dynamics. As mentioned above, the keystroke characteristic values may include the average depressed time and the average interim time, for example.

In block S28, the identifying module 28 determines if the keystroke characteristic values match the keystroke biometric template of the authorized user.

If the keystroke characteristic values match the keystroke biometric template of the authorized user, in block S30, the identifying module 28 grants access to the electronic device 1. If the keystroke characteristic values do not match the keystroke biometric template of the authorized user, in block S32 the identifying module 28 denies access to the electronic device 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for controlling access to an electronic device, the electronic device having a storage system and a keypad, the method comprising:
setting a username and a password of an authorized user of the electronic device;
creating a keystroke biometric template of the authorized user;
receiving an input username and an input password of a user, and recording keystroke dynamics of the user in response to keystroke actions on the keypad, the keystroke dynamics comprising a depressed time of each key of the keypad and an interim time between depression of two keys of the keypad;
determining if the input username and the input password are the same as the username and the password of the authorized user;
computing keystroke characteristic values of the user according to the keystroke dynamics if the input username and the input password are the same as the username and the password of the authorized user, the keystroke characteristic values comprising an average depressed time and an average interim time;
determining if the keystroke characteristic values match the keystroke biometric template of the authorized user; and
granting access to the electronic device if the keystroke characteristic values match the keystroke biometric template of the authorized user.

2. The method according to claim 1, further comprising:
denying access to the electronic device if either of the input username and the input password is different from the username and the password of the authorized user, or the keystroke characteristic values do not match the keystroke biometric template of the authorized user.

3. The method according to claim 1, wherein the creating step comprises:
recording keystroke dynamics of the authorized user in response to keystroke actions on the keypad;
computing keystroke characteristic values of the authorized user according to the keystroke dynamics;
creating the keystroke biometric template of the authorized user according to the keystroke characteristic values of the authorized user; and
storing the keystroke biometric template of the authorized user into the storage system.

4. The method according to claim 1, further comprising:
defining a comparison percentage to compare the keystroke characteristic values with the keystroke biometric template of the authorized user.

5. The method according to claim 1, wherein the electronic device is a mobile phone, a notebook computer, or a personal digital assistant.

6. An electronic device, the electronic device comprising:
a keypad;
a storage system that stores a keystroke biometric template of an authorized user of the electronic device;
at least one processor; and
one or more programs stored in the storage system and being executable by the at least one processor, the one or more programs comprising:
a setting module operable to set a username and a password of the authorized user;
a recording module operable to receive an input username and an input password of a user, and record keystroke dynamics of the user in response to keystroke actions on the keypad, the keystroke dynamics comprising a depressed time of each key of the keypad and an interim time between depression of two keys of the keypad;
a determining module operable to determine if the input username and the input password are the same as the username and the password of the authorized user;
a computing module operable to compute keystroke characteristic values of the user according to the keystroke dynamics if the input username and the input password are the same as the username and the password of the authorized user, the keystroke characteristic values comprising an average depressed time and an average interim time; and
an identifying module operable to determine if the keystroke characteristic values match the keystroke biometric template of the authorized user, and grant access to the electronic device if the keystroke characteristic values match the keystroke biometric template of the authorized user.

7. The electronic device according to claim 6, wherein the identifying module is further operable to deny access to the electronic device if either of the input username and the input password is different from the username and the password of the authorized user, or the keystroke characteristic values do not match the keystroke biometric template of the authorized user.

8. The electronic device according to claim 6, wherein:
the recording module is further operable to record keystroke dynamics of the authorized user in response to keystroke actions on the keypad;
the computing module is further operable to compute keystroke characteristic values of the authorized user according to the keystroke dynamics; and
the one or more programs further comprise a storing module operable to create the keystroke biometric template of the authorized user according to the keystroke characteristic values of the authorized user, and store the keystroke biometric template of the authorized user into the storage system.

9. The electronic device according to claim 6, wherein the setting module is further operable to define a comparison percentage to compare the keystroke characteristic values with the keystroke biometric template of the authorized user.

10. The electronic device according to claim 6, wherein the electronic device is a mobile phone, a notebook computer, or a personal digital assistant.

11. A storage medium storing a set of instructions, the set of instructions capable of being executed by a processor to perform a method for controlling access to an electronic device, the electronic device having a storage system and a keypad, the method comprising:
setting a username and a password of an authorized user of the electronic device;
creating a keystroke biometric template of the authorized user;
receiving an input username and an input password of a user, and recording keystroke dynamics of the user in response to keystroke actions on the keypad, the keystroke dynamics comprising a depressed time of each key of the keypad and an interim time between depression of two keys of the keypad;
determining if the input username and the input password are the same as the username and the password of the authorized user;
computing keystroke characteristic values of the user according to the keystroke dynamics if the input username and the input password are the same as the username and the password of the authorized user, the keystroke characteristic values comprising an average depressed time and an average interim time;
determining if the keystroke characteristic values match the keystroke biometric template of the authorized user; and
granting access to the electronic device if the keystroke characteristic values match the keystroke biometric template of the authorized user.

12. The storage medium as claimed in claim 11, wherein the method further comprises:
denying access to the electronic device if either of the input username and the input password is different from the username and the password of the authorized user, or the keystroke characteristic values do not match the keystroke biometric template of the authorized user.

13. The storage medium as claimed in claim 11, wherein the creating step comprises:
recording keystroke dynamics of the authorized user in response to keystroke actions on the keypad;
computing keystroke characteristic values of the authorized user according to the keystroke dynamics;
creating the keystroke biometric template of the authorized user according to the keystroke characteristic values of the authorized user; and
storing the keystroke biometric template of the authorized user into the storage system.

14. The storage medium as claimed in claim 11, wherein the method further comprises:
defining a comparison percentage to compare the keystroke characteristic values with the keystroke biometric template of the authorized user.

15. The storage medium as claimed in claim 11, wherein the electronic device is a mobile phone, a notebook computer, or a personal digital assistant.
